(19) United States
(12) Patent Application Publication
(10) Pub. No.: US 2018/0314563 A1
(43) Pub. Date: Nov. 1, 2018

(54) INFORMATION PROCESSING APPARATUS AND INFORMATION PROCESSING SYSTEM

(71) Applicant: FUJITSU LIMITED, Kawasaki-shi (JP)

(72) Inventors: Shogo SHIMURA, Kawasaki (JP); RYOICHI BAN, Suita (JP)

(73) Assignee: FUJITSU LIMITED, Kawasaki-shi (JP)

(21) Appl. No.: 15/955,868

(22) Filed: Apr. 18, 2018

(30) Foreign Application Priority Data
Apr. 26, 2017 (JP) 2017-087391

(51) Int. Cl. G06F 9/50; G06F 9/54

(52) U.S. Cl. CPC G06F 9/5055; G06F 9/5033; G06F 9/54

(57) ABSTRACT

An information processing apparatus includes a memory and a processor coupled to the memory. The memory is configured to store therein information in association with a specific service. The information specifies another service called in response to a request for using the specific service. The processor is configured to receive a request for using a first service provided by a server. The processor is configured to acquire information stored in the memory in association with the first service. The processor is configured to notify the server of the acquired information together with the received request.

### CROSS-REFERENCE TO RELATED APPLICATION

This application is based upon and claims the benefit of priority of the prior Japanese Patent Application No. 2017-087391, filed on Apr. 26, 2017, the entire contents of which are incorporated herein by reference.

### FIELD

The embodiments discussed herein are related to an information processing apparatus, an information processing system, and a non-transitory computer-readable medium having stored therein a program.

### BACKGROUND

Recently, a cloud service which provides a cloud computing technology has been provided in various forms. For example, in a platform as a service (PaaS) in which various applications are executable on a virtualized server, a user may call the application programming interface (API) of a virtual server and acquire an execution result. The cloud service includes, for example, an artificial intelligence service providing functions, such as natural language understanding, automatic voice recognition, image recognition, voice transformation, and machine learning.

Related techniques are disclosed in, for example, “Amazon AI”, [Online], <https://aws.amazon.com/jp/amazon-ai/>.

### SUMMARY

According to an aspect of the present invention, provided is an information processing apparatus including a memory and a processor coupled to the memory. The memory is configured to store therein information in association with a specific service. The information specifies another service called in response to a request for using the specific service. The processor is configured to receive a request for using a first service provided by a server. The processor is configured to acquire information stored in the memory in association with the first service. The processor is configured to notify the server of the acquired information together with the received request.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing system according to an embodiment;

FIG. 2 is a diagram illustrating an example of an API;

FIG. 3 is a block diagram illustrating an example of a configuration of a GW server according to an embodiment;

FIG. 4 is a diagram illustrating an example of a table storage unit;

FIG. 5 is a diagram illustrating an example of a table storage unit;

FIG. 6 is a diagram illustrating an example of a header of a purpose-specific API request;

FIG. 7 is a diagram illustrating an example of a display image in a semantic search for each professional field;

FIG. 8 is a sequence diagram illustrating an example of arrangement processing according to an embodiment;

FIG. 9 is a sequence diagram illustrating an example of providing processing according to an embodiment; and

FIG. 10 is a diagram illustrating an example of a computer that executes an information processing program.

### DESCRIPTION OF EMBODIMENTS

In the cloud service, in a case where the number of application programming interfaces (APIs) is relatively small, even when a function corresponds one-to-one to an API, such as corresponding an image recognition function to an image recognition API, a user may easily recognize the API provided by the cloud service. However, for example, when the number of APIs provided by the cloud service is increased and the user uses a function using the plurality of APIs, the user calls each of the plurality of APIs and the use of the cloud service becomes complex. Because of this, for example, a configuration is conceived in which a function using the plurality of APIs is configured as one purpose-specific API and a basic API that is an individual API is called. However, since a virtual server is arranged on the cloud service at the time of the application of the service, address information of the basic API is not determined until the arrangement of the virtual server is completed and it is difficult to pre-set the address information of the basic API in the purpose-specific API. Accordingly, even when the purpose-specific API is called by the user, it is difficult for the purpose-specific API to use the basic API.

Hereinafter, embodiments of an information processing apparatus, an information processing system, and a non-transitory computer-readable medium having stored therein a program disclosed in the present application will be described in detail with reference to the accompanying drawings. Further, the disclosed technology is not limited by the embodiment. Further, the embodiments below may be appropriately combined within the range having no contradiction.

### First Embodiment

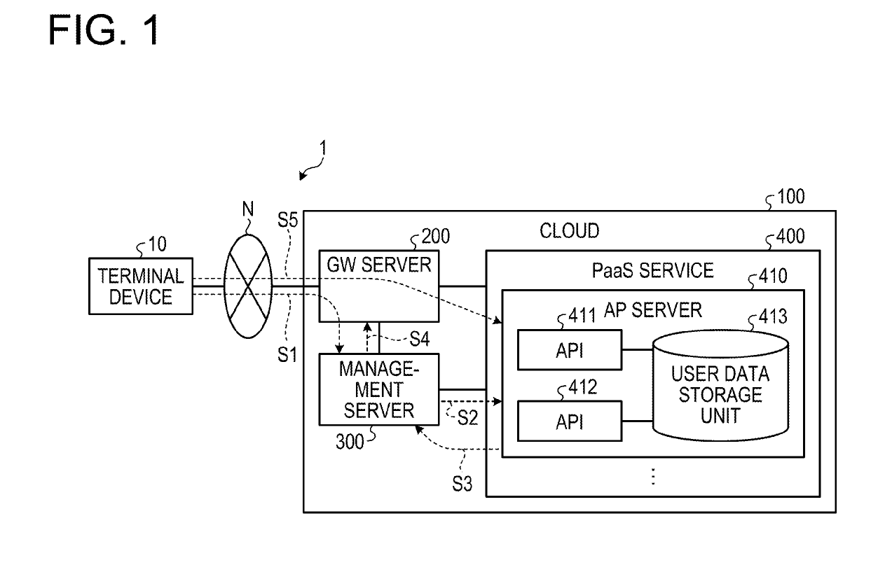

FIG. 1 is a diagram illustrating an example of a configuration of an information processing system according to an embodiment. An information processing system 1 illustrated in FIG. 1 includes a terminal device 10 and a cloud 100. The cloud 100 provides a cloud service and includes a gateway (GW) server 200, a management server 300, and a platform as a service (PaaS) service 400. Further, the PaaS service 400 includes an AP server 410 which is built for each user and executes various applications. That is, the GW server 200, the management server 300, and the AP server 410 are virtual servers operated on the cloud 100. Further, the numbers of terminal devices 10, GW servers 200, PaaS services 400, and AP servers 410 are not limited, and the predetermined numbers of terminal devices 10, GW servers 200, PaaS services 400, and AP servers 410 may be provided. The terminal device 10 and the GW server 200 are communicably connected via a network N. The network N may adopt the Internet and an arbitrary type of communication network, such as a local area network (LAN) or a virtual private network (VPN), regardless of a wired manner or a wireless manner.

The terminal device 10 is an information processing apparatus which a user of a cloud service provided by the cloud 100 uses. The terminal device 10 executes various processing on the AP server 410 by calling a purpose-specific API and the basic API provided from the AP server 410, and acquires an execution result. First, when the terminal device 10 initiates the use of the cloud service, the terminal device 10 transmits application information to the management server 300 via the network N and the GW server 200. The terminal device 10 receives log-in information from the management server 300 via the GW server 200 and the network N.

Next, when the terminal device 10 uses the cloud service, the terminal device 10 logs in to the cloud service and receives an access token by transmitting the log-in information to the GW server 200 via the network N. Further, the access token is written in a header of a request calling the API and indicates that the corresponding request is a request transmitted by the user of which an authentication is completed. The terminal device 10 transmits a purpose-specific API request corresponding to a service, of which an execution result is desired, to the AP server 410 via the network N and the GW server 200. That is, the terminal device 10 transmits a request for a use of a first service provided by the AP server 410 to the GW server 200. The terminal device 10 receives an execution result of processing for the request for the use from the AP server 410 via the GW server 200 and the network N.

The GW server 200 is an information processing apparatus which relays communication between the terminal device 10 and various servers of the cloud 100 and the like. When the GW server 200 receives the log-in information from the terminal device 10 via the network N, the GW server 200 executes authentication processing and generates an access token. The GW server 200 transmits the generated access token to the terminal device 10 via the network N.

The GW server 200 receives the request for the use of the first service provided by the AP server 410 from the terminal device 10. The GW server 200 acquires information associated with the first service by referring to a storage unit which associates information specifying another service called in response to a request for a use of a service with the corresponding service and stores the information. Further, the purpose-specific API is an example of a service, the basic API is an example of another service, and the address information of the basic API is an example of information specifying another service. The GW server 200 notifies the server of the acquired information together with the received request for the use. Accordingly, in the information processing system 1, the first service may use another service. That is, in the information processing system 1, the purpose-specific API may use the basic API.

The management server 300 is an information processing apparatus which manages information on the user of the terminal device 10 and arrangement information of the AP server 410. The management server 300 receives the application information from the terminal device 10 via the network N and the GW server 200. The management server 300 generates an arrangement instruction of the AP server 410 according to the application information. The management server 300 transmits the generated arrangement instruction to the PaaS service 400 and causes the PaaS service 400 to arrange the AP server 410 according to the arrangement instruction.

The management server 300 receives arrangement information of the AP server 410 arranged from the PaaS service 400. The management server 300 generates table setting information for setting a table of the GW server 200 and log-in information for logging in the cloud service by the terminal device 10 based on the received arrangement information. The management server 300 transmits the generated table setting information to the GW server 200, and transmits the generated log-in information to the terminal device 10 via the GW server 200 and the network N.

The AP server 410 is an information processing apparatus which is built for each user and executes various applications. The AP server 410 provides a purpose-specific API and a basic API for executing various applications. The AP server 410 includes, for example, APIs 411 and 412 and a user data storage unit 413. The APIs 411 and 412 are examples of a purpose-specific API and a basic API. The user data storage unit 413 stores a data region set for each user of the terminal device 10 contracting the cloud service.

The AP server 410 receives a purpose-specific API request of which a header is updated from the GW server 200. The AP server 410 specifies an address of the basic API used by the called purpose-specific API. The AP server 410 executes processing of the request by using the basic API of the specified address. The AP server 410 transmits an execution result to the terminal device 10 via the GW server 200 and the network N.

That is, the AP server 410 specifies an address of another service used by the called first service according to the notification from the GW server 200. The AP server 410 executes processing for the request for the use by using another service of the specified address and transmits an execution result to the terminal device 10.

Herein, a flow of the processing of the information processing system 1 will be described with reference to FIG. 1. First, the terminal device 10 transmits application information to the management server 300 via the network N and the GW server 200 (step S1). When the management server 300 receives the application information from the terminal device 10, the management server 300 generates an arrangement instruction of the AP server 410 according to the application information. The management server 300 transmits the generated arrangement instruction to the PaaS service 400 (step S2). When the PaaS service 400 receives the arrangement instruction, the PaaS service 400 arranges the AP server 410 according to the arrangement instruction and transmits arrangement information to the management server 300 (step S3). Further, the arrangement information includes address information of a basic API used by a purpose-specific API.

The management server 300 generates table setting information based on the received arrangement information and transmits the generated table setting information to the GW server 200. The GW server 200 stores the received table setting information in the table storage unit (step S4). Then, when the GW server 200 receives a purpose-specific API request from the terminal device 10, the GW server 200 adds address information on the basic API used by the corresponding purpose-specific API to the purpose-specific API request by referring to the table storage unit. The GW server 200 transmits the purpose-specific API request to which the address information of the basic API is added to the AP server 410 (step S5). Accordingly, the AP server 410 is aware of the address information on the basic API used by the purpose-specific API, so that the purpose-specific API may execute the requested processing by using the basic API.

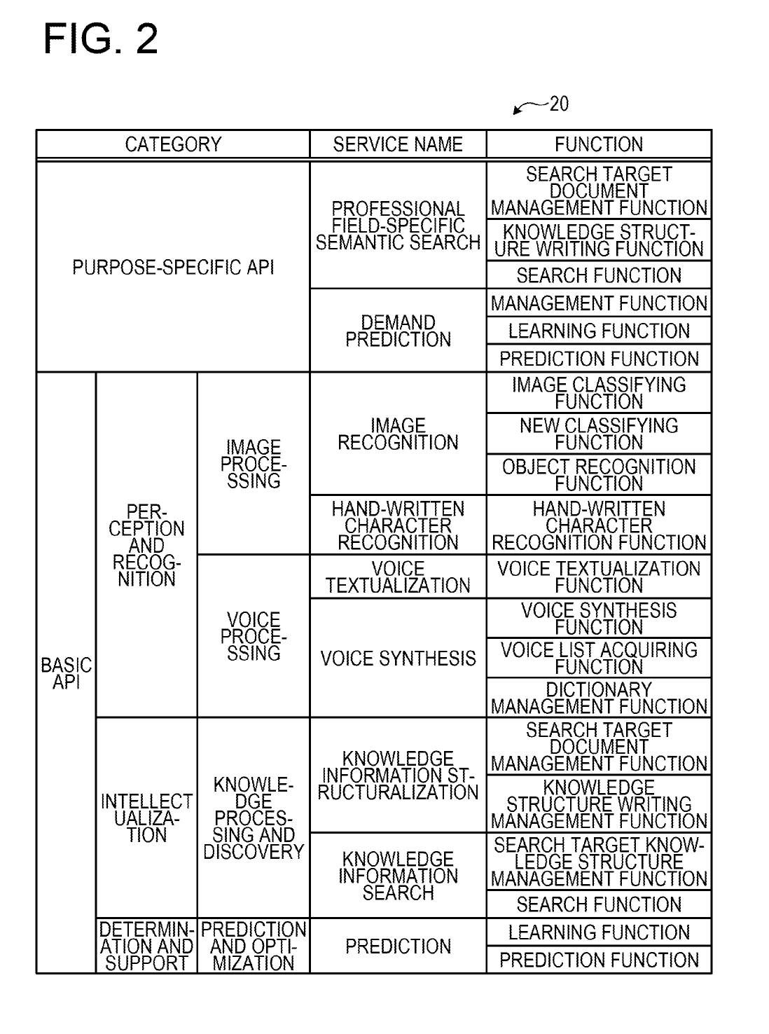

Herein, the purpose-specific API and the basic API will be described with reference to FIG. 2. FIG. 2 is a diagram illustrating an example of an API. In Table 20 illustrated in FIG. 2, the purpose-specific API and the basic API are classified. A box “category” of Table 20 indicates a category of an API. A box “service name” indicates a name of a service, that is, an “API” called by a user. A box “function” indicates a function of each service, that is, processing executed by each API. In Table 20, for example, the purpose-specific API includes a semantic search API for each professional field and a demand estimation API. The semantic search API for each professional field has functions, for example, a “search target document management function”, a “knowledge structure writing function”, and a “search function”. The demand estimation API also identically has the functions indicated in the box “function”.

In Table 20, the basic API is classified in a hierarchy, and is classified into, for example, “Perception and recognition”, “Intellectualization”, and “Determination and support”. “Perception and recognition” is re-classified into, for example, “image processing” and “voice processing” as a sub category. “Intellectualization” has, for example, “knowledge processing and discovery” as a sub category. “Determination and support” has, for example, “prediction and optimization” as a sub category. The category “image processing” has, for example, an image recognition API and a hand-writing character recognition API. The category “voice processing” has, for example, a voice textualization API and a voice synthesis API. The category “knowledge processing and discovery” has, for example, a knowledge information structurization API and a knowledge information search API. The category “prediction and optimization” has, for example, a prediction API. The basic API has each of the functions indicated in the box “function” identically to the purpose-specific API.

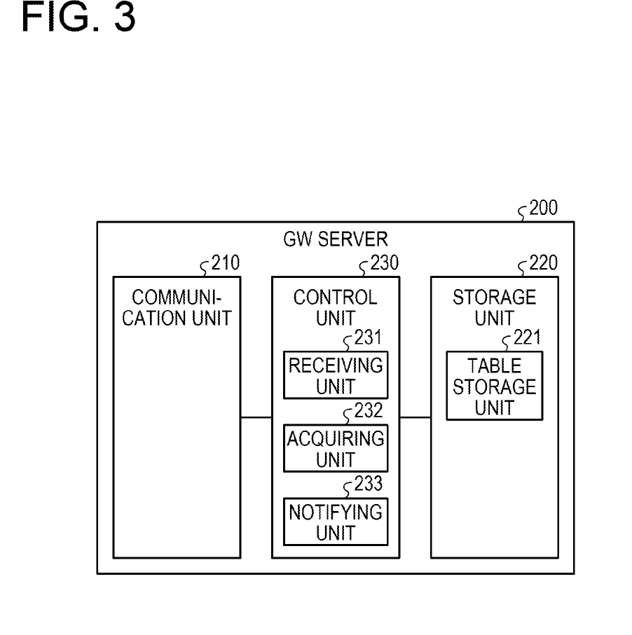

Next, the configuration of the GW server 200 will be described. FIG. 3 is a block diagram illustrating an example of the configuration of the GW server according to the embodiment. As illustrated in FIG. 3, the GW server 200 includes a communication unit 210, a storage unit 220, and a control unit 230. Further, in addition to the functional units illustrated in FIG. 3, the GW server 200 may include various functional units included in a known computer, for example, functional units, such as various input devices or voice output devices.

The communication unit 210 is implemented by, for example, a network interface card (NIC). The communication unit 210 is connected with the terminal device 10 via the network N via a wire or wirelessly, and is a communication interface performing the communication of the information with the terminal device 10. Further, the communication unit 210 is a communication interface performing the communication of the information with the management server 300 and the PaaS service 400 within the cloud 100. Further, the communication unit 210 may be assigned a physical NIC of the cloud 100, and may be a virtualized NIC so that the cloud 100 may use the physical NIC by a plurality of virtual servers.

The communication unit 210 outputs the table setting information received from the management server 300 to the control unit 230. The communication unit 210 outputs the log-in information and the purpose-specific API request received from the terminal device 10 to the control unit 230. Further, the communication unit 210 transmits an access token input from the control unit 230 to the terminal device 10. The communication unit 210 transmits the purpose-specific API request input from the control unit 230 to the AP server 410.

The storage unit 220 is implemented by, for example, a semiconductor memory device, such as a random access memory (RAM) or a flash memory, and a storage device, such as a hard disk or an optical disk. The storage unit 220 includes a table storage unit 221. Further, the storage unit 220 stores information used for processing by the control unit 230.

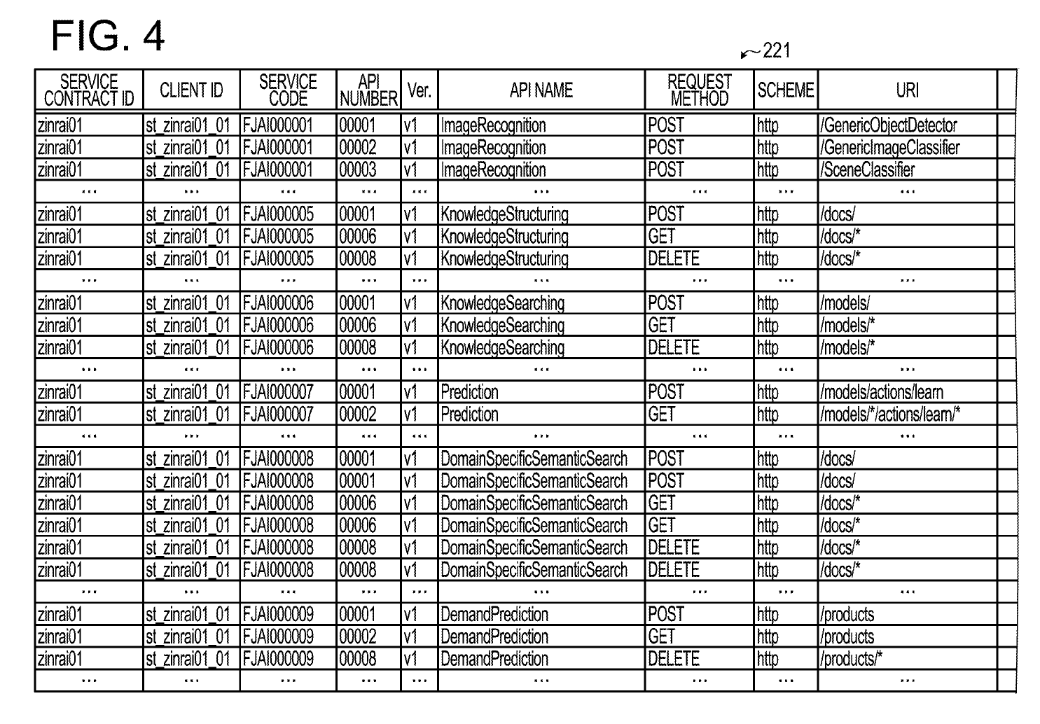

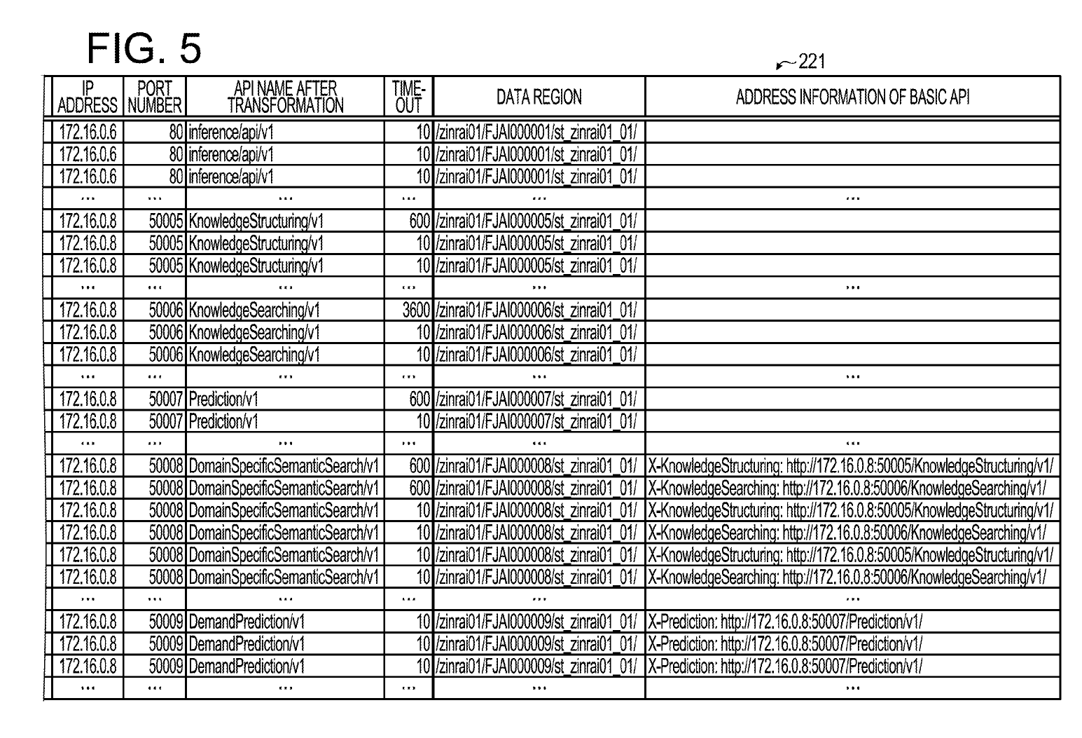

The table storage unit 221 stores a table in which a purpose-specific API is associated with address information of a basic API used by the corresponding specific-purpose API. That is, the table storage unit 221 associates information specifying another service called according to a request for a use of a service with a corresponding service and stores the information. FIGS. 4 and 5 are diagrams illustrating an example of the table storage unit. As illustrated in FIGS. 4 and 5, the table storage unit 221 has items “Service Contract Identifier (ID)”“Client ID”, “Service Code”, “API Number”, “Ver.”, “API name”, and “Request Method”. Further, the table storage unit 221 has items “Scheme”, “Uniform Resource Identifier (URI)”, and “Internet Protocol (IP) Address”. Further, the table storage unit 221 has items “Port Number”, “API Name after Transformation”, “Timeout”, “Data Region”, and “Address Information of Basic API”.

The “Service Contract ID” is an identifier identifying a user contracting the cloud service. The “Service Contract ID” is associated with, for example, a client ID and a service code, and is used for charging processing and the like in the cloud service. The “Client ID” is an identifier identifying each account when a plurality of accounts using the service within one contract is written. The “Service Code” is an identifier identifying a name of a service provided by the cloud service, that is, a purpose-specific API and a basic API. The “API Number” is an identifier identifying an operation within each API.

“Ver.” is information indicating a version of the API. The “API Name” is information indicating a name of each API, that is, a purpose-specific API and a basic API. The “Request Method” is information indicating a method of a hypertext transfer protocol (HTTP), and is information indicating a type of request for each API, that is, a purpose-specific API and a basic API. The “Request Method” includes, for example, “POST”, “GET”, and “DELETE”. The “POST” is, for example, a request for transmitting information from the terminal device 10 to a resource designated by an URI of the AP server 410. The “GET” is, for example, a request for acquiring, by the terminal device 10, information from the resource designated by the URI of the AP server 410. The “DELETE” is, for example, a request for deleting, by the terminal device 10, information about the resource designated by the URI of the AP server 410.

The “Scheme” is information indicating a scheme in a request for each API, that is, a type of a communication protocol and the like. The “Scheme” may include, for example, “http” and “https”. Further, “http” and “https” indicate an HTTP and hypertext transfer protocol secure (HTTPS), respectively. The “URI” is an identifier identifying a resource corresponding to each API of the AP server 410.

The “IP Address” is information indicating an IP address of the AP server 410. Further, the “IP Address” may indicate each API. The “Port Number” is information indicating a port number corresponding to each API in the AP server 410. The “API Name after Transformation” is information indicating an API which substantially executes processing. For example, when the API has a plurality of versions, the “API Name after Transformation” is an API name in which even a version is designated. Further, for example, when an API calls an API provided by an external system, the “API Name after Transformation” is an API name of the corresponding external system or an API name in which version information is designated. In the example of FIGS. 4 and 5, in the API name “Image Recognition” in the first row, a server assigned an IP address “172.16.0.6” that is different from an IP address “172.16.0.8” of the AP server 410 is designated. Port number “80” of the designated server is associated with an API indicated by the API name after transformation “inference/api/v1”.

The “Timeout” indicates a value for determining a time from when the API is called and the processing is started until a response is received as timeout, and a unit thereof is a second. The “Data Region” is information indicating a region in which data of each user is preserved. The “Data Region” is provided in the user data storage unit 413. The “Address Information of Basic API” is information, such as address information of a basic API used by a corresponding purpose-specific API, that is, an IP address, a port number, and an API name after transformation, when the API is the purpose-specific API. Further, the “Address Information of Basic API” may store information to be added to a header of the purpose-specific API request as it is. Further, when the API is the basic API, the “Address Information of Basic API” is vacant.

That is, the table storage unit 221 associates information specifying another service called according to a request for a use of a service with a corresponding service and stores the information. Further, the table storage unit 221 stores information specifying another service corresponding to a service and data region information set for each user of the terminal device 10.

Referring back to the description of FIG. 3, the control unit 230 is implemented, for example, by executing a program stored in an internal memory device in a RAM as a work area by, for example, a central processing unit (CPU) or a micro processing unit (MPU). Further, the control unit 230 may be implemented by, for example, an integrated circuit, such as an application specific integrated circuit (ASIC) or a field programmable gate array (FPGA). The control unit 230 includes a receiving unit 231, an acquiring unit 232, and a notifying unit 233, and implements or carries out a function or an action of the information processing (to be described later). Further, the internal configuration of the control unit 230 is not limited to the configuration illustrated in FIG. 3, and as long as internal configuration of the control unit 230 performs information processing (to be described later), the internal configuration may have another configuration.

The receiving unit 231 sets table setting information in the table storage unit 221 during the arrangement processing of arranging the AP server 410. The receiving unit 231 receives the table setting information from the management server 300 via the communication unit 210. The receiving unit 231 stores the received table setting information in the table storage unit 221.

The receiving unit 231 performs authentication processing and processing of receiving a purpose-specific API request during the processing of providing, by the AP server 410, the API. The receiving unit 231 receives log-in information from the terminal device 10 via the network N and the communication unit 210. The receiving unit 231 executes the authentication processing based on the received log-in information, and generates an access token capable of specifying a user of the terminal device 10. The receiving unit 231 transmits the generated access token to the terminal device 10 via the communication unit 210 and the network N.

The receiving unit 231 receives the purpose-specific API request from the terminal device 10 via the network N and the communication unit 210. The receiving unit 231 receives the received purpose-specific API request and outputs the received purpose-specific API request to the acquiring unit 232. Further, the receiving unit 231 receives a basic API request and outputs the received basic API request to the acquiring unit 232, identically to a case where the basic API request is received from the terminal device 10. That is, the receiving unit 231 receives a request for a use of the purpose-specific API that is a first service provided by the AP server 410 from the terminal device 10.

When the purpose-specific API request is input from the receiving unit 231, the acquiring unit 232 acquires the address information of the basic API used by the purpose-specific API and the data region information of the user by referring to the table storage unit 221. The acquiring unit 232 outputs the acquired address information of the basic API, the acquired data region information of the user, and the purpose-specific API request to the notifying unit 233. Further, when the basic API request is input from the receiving unit 231, the acquiring unit 232 acquires the data region information of the user by referring to the table storage unit 221. The acquiring unit 232 outputs the acquired data region information of the user and the basic API request to the notifying unit 233.

That is, the acquiring unit 232 acquires information associated with the first service by referring to the table storage unit 221. Further, the acquiring unit 232 acquires the data region information of the user of the terminal device 10 by referring to the table storage unit 221.

The address information of the basic API, the data region information of the user, and the purpose-specific API request are input to the notifying unit 233 from the acquiring unit 232. The notifying unit 233 adds the address information of the basic API and the data region information to a header of the purpose-specific API request to update the header of the request. The notifying unit 233 transmits the purpose-specific API request of which the header is updated to the AP server 410. Further, when the data region information of the user and the basic API request are input to the notifying unit 233, the notifying unit 233 adds the data region information to a header of the basic API request to update the header of the request. In this case, the notifying unit 233 transmits the basic API request of which the header is updated to the AP server 410.

That is, the notifying unit 233 notifies the AP server 410 of the acquired information together with the received request for the use. Further, the notifying unit 233 notifies the AP server 410 of the acquired data region information. Further, the notifying unit 233 stores one or a plurality of elements of information among the use requested first service, the acquired information specifying another service, and the data region information in the header of the received request for the use and notifies the AP server 410 of the information.

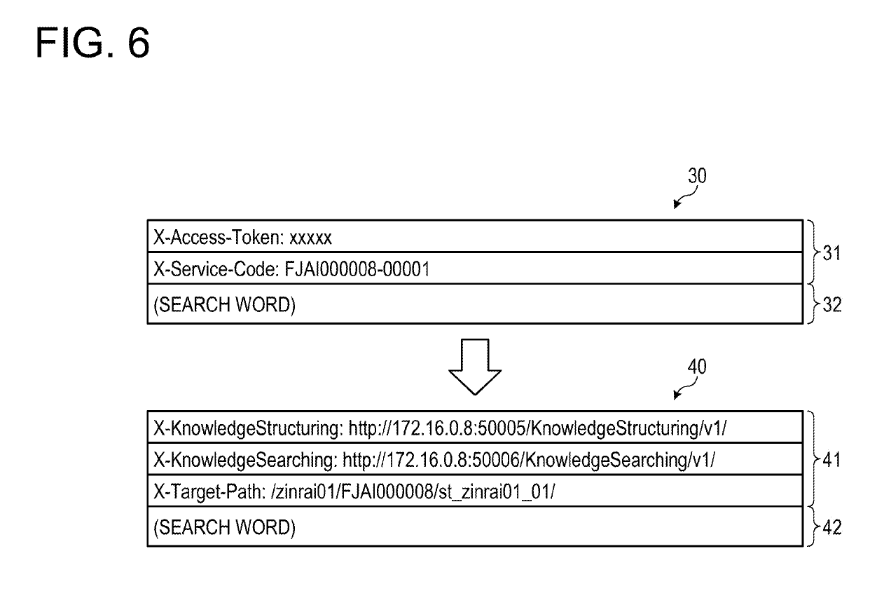

Herein, the addition of the information to the header of the purpose-specific API request will be described with reference to FIG. 6. FIG. 6 is a diagram illustrating an example of a header of a purpose-specific API request. A purpose-specific API request 30 illustrated in FIG. 6 has a request header 31 and data 32. The request header 31 includes an access token and a purpose-specific API. In FIG. 6, the access token is indicated by “X-Access-Token:xxxxx” and the purpose-specific API is indicated by “X-Service-Code:FJAI000008-00001”. Data for the processing of the purpose-specific API is included in the data 32. For example, a search word is included in the request 30 as data.

In a purpose-specific API request 40 illustrated in FIG. 6, the notifying unit 233 adds address information of a basic API and data region information to a request header. The purpose-specific API request 40 includes a request header 41 and data 42. The address information of the basic API and the data region information are included in the request header 41. Further, the request header 41 may include an access token and a purpose-specific API. In FIG. 6, the address information of the basic API is indicated by “X-KnowledgeStructuring: http://172.16.0.8:50005/KnowledgeStructuring/v1/” and “X-KnowledgeSearching: http://172.16.0.8:50006/KnowledgeSearching/v1/”. Further, in FIG. 6, the data region information is indicated by “X-Target-Path:/zinrai01/FJAI000008/st_zinrai01_01/”. Further, the data region information may designate, for example, a contract number or a service contract ID, a service code, and a client ID to specify a data region.

Data about the processing of the purpose-specific API is included in the data 42. Further, the data 42 is the same as the data 32. That is, the purpose-specific API request 40 indicates a state in which the request header of the purpose-specific API request 30 is updated. As described above, the address information of the basic API and the data region information are added to the request header, so that in the AP server 410, the purpose-specific API may use the basic API based on the purpose-specific API request 40.

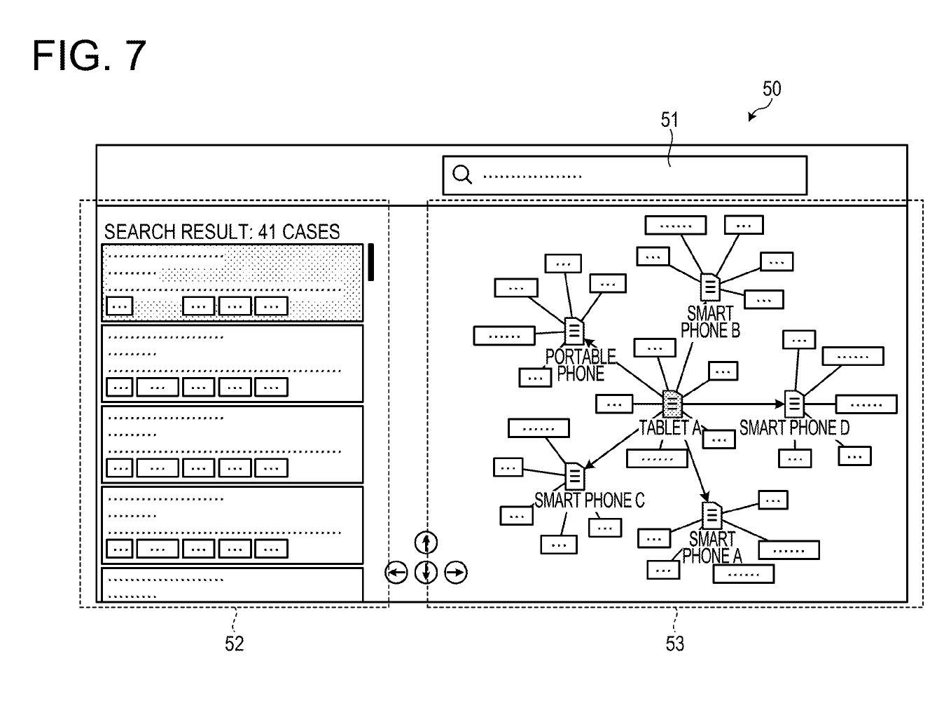

A display image displayed on the terminal device 10 when the purpose-specific API is called will be described with reference to FIG. 7. FIG. 7 is a diagram illustrating an example of a display image in a semantic search for each professional field. A display image 50 illustrated in FIG. 7 is an example of a display image displayed when a professional field-specific semantic search is called as a purpose-specific API. Further, the professional field-specific semantic search uses knowledge information search and knowledge information structurization as a basic API.

The display image 50 has an input region 51 of a search word, a display region 52 of a search result, and a display region 53 of a graph in which the search result is structurized. The input region 51 receives an input of a search word desired to be searched by the professional field-specific semantic search. The display region 52 of the search result displays a search result of the received search word. That is, the display region 52 of the search result displays an execution result of the processing of the knowledge information search that is the basic API. Further, the display region 52 of the search result may display a plurality of keywords indicating a characteristic of a search document, in addition to the general search result.

The display region 53 of the graph displays, for example, a structurized graph indicating semantic proximity of another search document based on one search document. That is, the display region 53 of the graph displays an execution result of the processing of the knowledge information structurization that is the basic API.

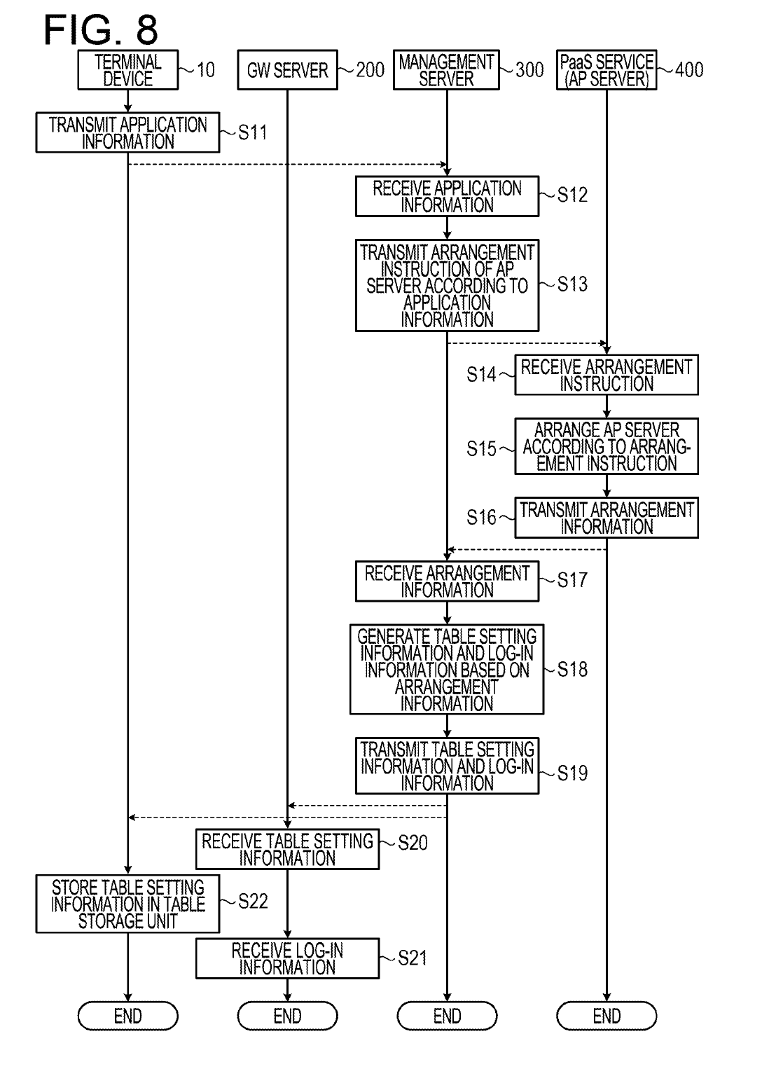

Next, an operation of the information processing system 1 according to the embodiment will be described. First, the arrangement processing will be described with reference to FIG. 8. FIG. 8 is a sequence diagram illustrating an example of the arrangement processing according to the embodiment.

The terminal device 10 transmits application information to the management server 300 (step S11). The management server 300 receives the application information from the terminal device 10 (step S12). The management server 300 generates an arrangement instruction of the AP server 410 according to the application information. The management server 300 transmits the generated arrangement instruction to the PaaS service 400 (step S13). The PaaS service 400 receives the arrangement instruction from the management server 300 (step S14). The PaaS service 400 arranges the AP server 410 according to the arrangement instruction (step S15). The PaaS service 400 transmits the arrangement information of the AP server 410 to the management server 300 (step S16).

The management server 300 receives the arrangement information of the AP server 410 from the PaaS service 400 (step S17). The management server 300 generates table setting information and log-in information based on the received arrangement information (step S18). The management server 300 transmits the generated table setting information to the GW server 200 and transmits the generated log-in information to the terminal device 10 (step S19).

The receiving unit 231 of the GW server 200 receives the table setting information from the management server 300 (step S20). The receiving unit 231 stores the received table setting information in the table storage unit 221 (step S21). The terminal device 10 receives the log-in information from the management server 300 (step S22). Accordingly, the information processing system 1 may arrange the AP server 410, and store the table setting information based on the arrangement information in the GW server 200.

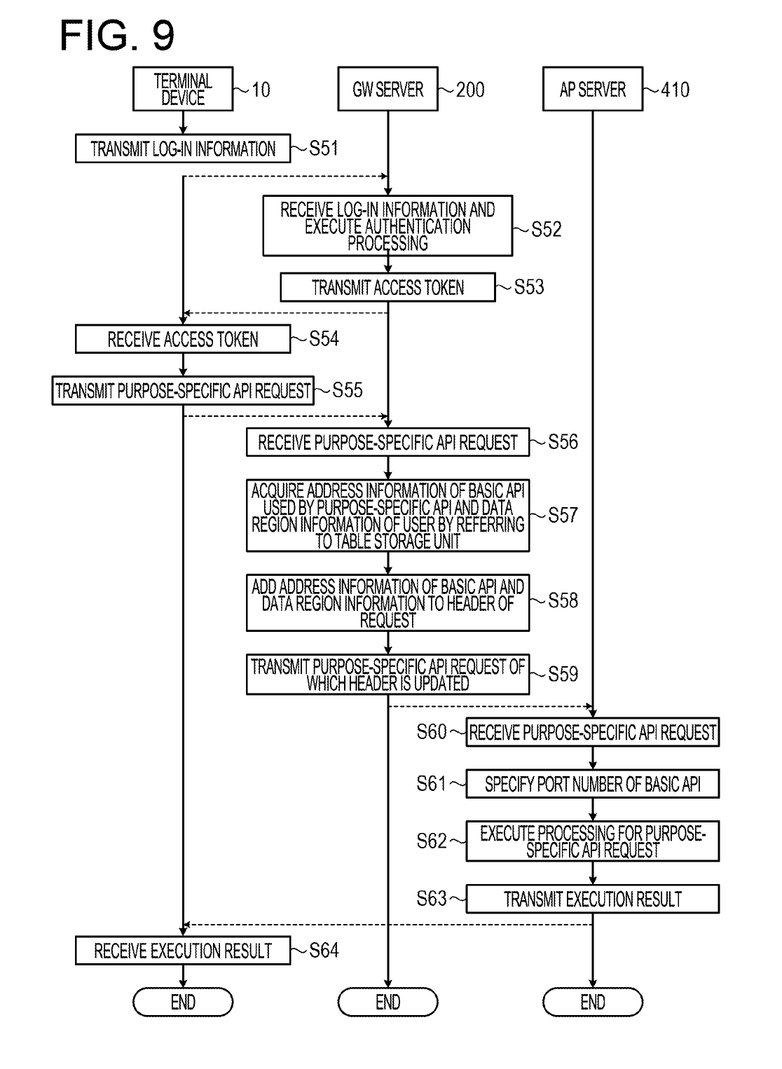

Next, providing processing will be described with reference to FIG. 9. FIG. 9 is a sequence diagram illustrating an example of providing processing according to the embodiment.

The terminal device 10 transmits log-in information to the GW server 200 (step S51). The receiving unit 231 of the GW server 200 receives the log-in information from the terminal device 10. The receiving unit 231 executes authentication processing based on the received log-in information, and generates an access token capable of specifying a user of the terminal device 10 (step S52). The receiving unit 231 transmits the generated access token to the terminal device 10 (step S53).

The terminal device 10 receives the access token from the GW server 200 (step S54). The terminal device 10 transmits the purpose-specific API request corresponding to a service of which an execution result is desired to the GW server 200 before the AP server 410 (step S55).

The receiving unit 231 of the GW server 200 receives the purpose-specific API request from the terminal device 10 (step S56). The receiving unit 231 receives the received purpose-specific API request and outputs the received purpose-specific API request to the acquiring unit 232.

When the purpose-specific API request is input from the receiving unit 231, the acquiring unit 232 acquires address information of a basic API used by the purpose-specific API and data region information of the user by referring to the table storage unit 221 (step S57). The acquiring unit 232 outputs the acquired address information of the basic API, the acquired data region information of the user, and the purpose-specific API request to the notifying unit 233.

The address information of the basic API, the data region information of the user, and the purpose-specific API request are input to the notifying unit 233 from the acquiring unit 232. The notifying unit 233 adds the address information of the basic API and the data region information to a header of the purpose-specific API request to update the header of the request (step S58). The notifying unit 233 transmits the purpose-specific API request of which the header is updated to the AP server 410 (step S59).

The AP server 410 receives the purpose-specific API request of which the header is updated from the GW server 200 (step S60). The AP server 410 specifies an address, that is, a port number of the basic API used by the called purpose-specific API (step S61). Further, when the IP address of the purpose-specific API is different from the IP address of the basic API, the AP server 410 specifies the IP address and the port number of the basic API. The AP server 410 executes processing for the purpose-specific API request by using the basic API having the specified port number (address) (step S62). The AP server 410 transmits an execution result to the terminal device 10 (step S63).

The terminal device 10 receives the execution result of the processing for the purpose-specific API request from the AP server 410 (step S64). Accordingly, in the information processing system 1, the purpose-specific API may use the basic API. That is, when the request passes through the GW server 200, the address information on the basic API used by the purpose-specific API is added to the request, so that in the AP server 410, the purpose-specific API may execute the requested processing by using the basic API.

As described above, the GW server 200 receives a request for a use of the first service provided by the AP server 410. Further, the GW server 200 acquires information associated with the first service by referring to the table storage unit 221 which associates information specifying another service called in response to the request for the use of the service with the corresponding service and stores the information. Further, the GW server 200 notifies the AP server 410 of the acquired information together with the received request for the use. As a result, in the AP server 410, the first service may use another service. That is, in the AP server 410, the purpose-specific API may use the basic API.

In the GW server 200, the table storage unit 221 stores information specifying another service corresponding to a service and data region information set for each user. Further, the GW server 200 acquires data region information of a user. Further, the GW server 200 notifies the AP server 410 of the acquired data region information. As a result, in the AP server 410, the first service and another service may use the data region of the user. That is, in the AP server 410, the purpose-specific API and the basic API may use the data region of the user.

The GW server 200 stores one or a plurality of elements of information among the use requested first service, the acquired information specifying another service, and the data region information in a header of the received request for the use and notifies the AP server 410 of the information. As a result, the GW server 200 may provide the AP server 410 with the information required for processing the request for the use.

The information processing system 1 includes the terminal device 10, the GW server 200, and the AP server 410. The terminal device 10 transmits a request for a use of a service provided by the AP server 410 to the GW server 200. The GW server 200 receives the request for the use from the terminal device 10. Further, the GW server 200 acquires information associated with the first service by referring to the table storage unit 221 which associates information specifying another service called in response to the request for the use of the service with the corresponding service and stores the information. Further, the GW server 200 notifies the AP server 410 of the acquired information together with the received request for the use. The AP server 410 specifies an address of another service used by the called first service according to the notification from the GW server 200. Further, the AP server 410 executes processing for the request for the use by using another service of the specified address and transmits an execution result to the terminal device 10. As a result, in the information processing system 1, the first service may use another service. That is, in the information processing system 1, the purpose-specific API may use the basic API.

In the embodiment, the present disclosure has been described by using the case where the terminal device 10 calls the API within the cloud 100 as an example, but the present disclosure is not limited thereto. For example, the terminal device 10 may call an API provided by an external system. In this case, the GW server 200 transmits an API request from the corresponding external system and acquires an execution result from the external system.

In the embodiment, the user data storage unit 413 is provided in the AP server 410, but the present disclosure is not limited thereto. For example, a server may be provided separately from the AP server 410, and the corresponding server may include the user data storage unit 413.

Each constituent element of each illustrated unit is not essentially physically configured as illustrated in the drawing. That is, a specific form of a dispersion or a combination of the respective units is not limited to the illustration, and the entirety or the part of the units may be configured to be functionally or physically dispersed and combined on a predetermined unit basis according to various loads, a usage situation, and the like. For example, the acquiring unit 232 and the notifying unit 233 may be combined. Further, the respective processing as illustrated is not limited to the foregoing sequence, and respective processing may be simultaneously performed and may be performed in a changed order within a range having no contradiction of processing contents.

The entirety or a part of the various processing functions performed by the respective devices may be implemented by a CPU (or a microcomputer, such as an MPU and a micro controller unit (MCU)). Further, it is a matter of course that the various processing functions may well be entirely or partially executed in a program interpreted and executed by the CPU (or the microcomputer, such as an MPU and an MCU) or hardware by wired logic.

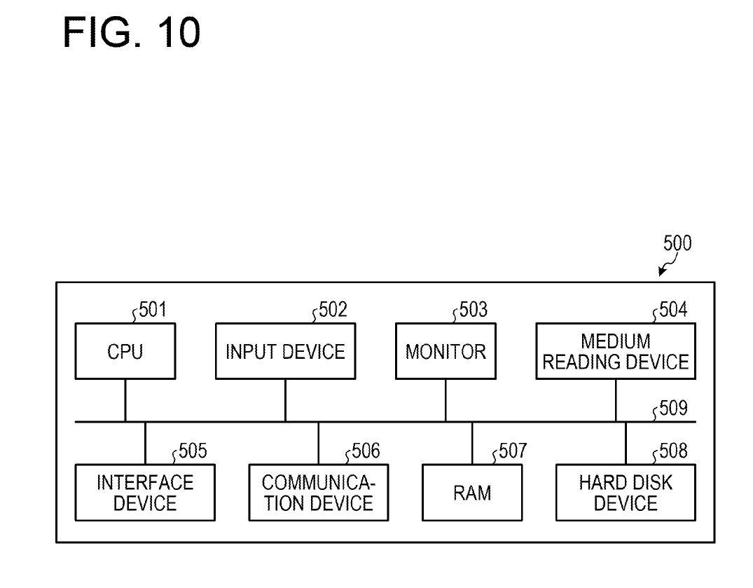

However, various processing described in the embodiment may be implemented by executing a prepared program in a computer. Accordingly, hereinafter, an example of a computer executing a program having the same function as that of the embodiment will be described. FIG. 10 is a diagram illustrating an example of a computer executing an information processing program.

As illustrated in FIG. 10, a computer 500 includes a CPU 501 which executes various calculation processing, an input device 502 which receives data input, and a monitor 503. Further, the computer 500 includes a medium reading device 504 which reads a program and the like from a storage medium, an interface device 505 for a connection with various devices, and a communication device 506 to be connected with another information processing device and the like via a wire or wirelessly. Further, the computer 500 includes a RAM 507 which temporarily stores various elements of information, and a hard disk device 508. Further, each of the devices 501 to 508 is connected to a bus 509.

An information processing program having the same function as that of each processing unit of the receiving unit 231, the acquiring unit 232, and the notifying unit 233 as illustrated in FIG. 3 is stored in the hard disk device 508. Further, the table storage unit 221 and various data for implementing the information processing program are stored in the hard disk device 508. The input device 502 receives, for example, an input of various elements of information, such as operation information, from a manger of the computer 500. For example, the monitor 503 displays various screens, such as a display screen, to the manager of the computer 500. For example, the interface device 505 is connected with a printing device and the like. For example, the communication device 506 has the same function as that of the communication unit 210 illustrated in FIG. 3, is connected with the network N, and exchanges various elements of information with the terminal device 10 and the like.

The CPU 501 reads each program stored in the hard disk device 508 and develops and executes the read program in the RAM 507 to perform various processing. Further, the program may cause the computer 500 to serve as the receiving unit 231, the acquiring unit 232, and the notifying unit 233 as illustrated in FIG. 3.

The information processing program is not necessarily stored in the hard disk device 508. For example, the computer 500 may read and execute a program stored in a storage medium readable by the computer 500. The storage medium readable by the computer 500 corresponds to, for example, a CD-ROM or a DVD disk, a portable recording medium, such as a universal serial bus (USB) memory, a semiconductor memory, such as a flash memory, and a hard disk drive. Further, the information processing program may be stored, for example, in a device connected to a public line, the Internet, or a local area network (LAN), and the computer 500 may read the information processing program from the public line, the Internet, the LAN, or the like and execute the information processing program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a memory configured to:
store therein information in association with a specific service, the information specifying another service called in response to a request for using the specific service; and
a processor coupled to the memory and configured to:
receive a request for using a first service provided by a server;
acquire information stored in the memory in association with the first service; and
notify the server of the acquired information together with the received request.

2. The information processing apparatus according to claim 1, wherein
the memory is further configured to:
store therein, for each user, the information specifying another service and data region information, and
the processor is further configured to:
acquire the data region information of the user; and
notify the server of the acquired data region information.

3. The information processing apparatus according to claim 2, wherein
the processor is further configured to:
store one or a plurality of elements of information among the first service, the information specifying another service, and the data region information in a header of the received request; and
notify the server of the request.

4. A non-transitory computer-readable medium having stored therein a program that causes a computer to execute a processing, the processing comprising:
storing information in a memory in association with a specific service, the information specifying another service called in response to a request for using the specific service;
receiving a request for using a first service provided by a server;
acquiring information stored in the memory in association with the first service; and
notifying the server of the acquired information together with the received request.

5. An information processing system, comprising:
a terminal device;
an information processing apparatus; and
a server,
wherein
the terminal device is configured to:
transmit a first request for using a first service provided by the server to the information processing apparatus,
the information processing apparatus includes:
a memory; and
a processor coupled to the memory and configured to:
store information in a memory in association with a specific service, the information specifying another service called in response to a request for using the specific service;
receive the first request from the terminal device;
acquire information stored in the memory in association with the first service; and
notify the server of the acquired information together with the first request, and
the server is configured to:
receiving the information together with the first request from the information processing apparatus;
identify an address of a second service specified by the received information;
execute processing for the first request by using the second service at the identified address; and
transmit a result of the execution to the terminal device.
